(19) United States
(12) Patent Application Publication
(10) Pub. No.: US 2004/0240889 A1
(43) Pub. Date: Dec. 2, 2004

(54) Clock extraction apparatus and method for optical signal

(76) Inventors: Wang Joo Lee, Daejeon (KR); Hyun Woo Cho, Seoul (KR); Ki Ho Han, Busan (KR); Je Soo Ko, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/717,796

(22) Filed: Nov. 19, 2003

(30) Foreign Application Priority Data
May 30, 2003 (KR) 2003-0034790

(51) Int. Cl. H04B 10/00

(52) U.S. Cl. 398/155

(57) ABSTRACT

The present invention provides a clock extraction apparatus and method for an optical signal. The clock extraction apparatus includes optical branching means, optical filtering means, and clock extraction means. The optical branching means branches an optical signal, which has been transmitted from a transmitting end to a receiving end, into a plurality of optical signals to be transmitted to a plurality of paths. The optical filtering means simultaneously reflects the center wavelength and a specific side peak wavelength of the optical signal, which has been transmitted to a first path of the plurality of paths, to the optical branching means, the specific side peak wavelength being spaced apart from the center wavelength by a clock frequency. The clock extraction means extracts a clock by detecting and bandpass filtering the beating signal from the center wavelength and the specific side peak wavelength reflected to the optical branching means.

### BACKGROUND OF THE INVENTION

1. Field of the Invention

The present invention relates generally to a clock extraction apparatus and method for an optical communication signal, and more particularly to a clock extraction apparatus and method for an optical signal, which simultaneously extracts a center wavelength and a specific side peak wavelength using a single optical filter and generates beating signal between the two wavelengths, thereby extracting a stable clock, and which amplifies the magnitude of the side peak wavelength at a transmitting end, thereby increasing the transmission distance of the optical communication signal.

2. Description of the Prior Art

In a digital communication system, in order to reconstruct original data using received data, it is essential to extract a clock from the received data. The reconstruction of data at the receiving end of the digital communication system is to determine whether the value of input data is “0” or “1” by reading the input data at regular time intervals using a clock. If a clock rate at the receiving end is different from the clock rate at a transmitting end, the received data is not normally reconstructed into the original data as time elapses, so that almost all receivers employ a method of directly extracting a clock from the received data.

A conventional clock extraction method uses a Phase Locked Loop (PLL) device. The clock extraction method separates a part of received data, inputs one part of received data to a PLL circuit in an electrical signal form, and uses the output of the PLL circuit as a clock. However, a data transmission rate exceeded 10 Gbps after the advent of an optical communication, and systems having a data transmission rate greater than 40 Gbps are being vigorously investigated at the present time. For such a high frequency range, it is difficult to fabricate electrical devices, including the PLL device, so that attempts are simultaneously being made to relatively easily extract a clock through an optical method.

Currently, for a method of optically extracting a clock in the optical communication, there are being studied a self-pulsating method using a laser diode, a method using an optical loop mirror, etc. However, problems, such as the difficulty of the manufacture of a device for extracting a desired clock and the instability of an optical system, remain still.

A method, which is presently known and has relatively high stability, is to generate a clock by extracting a center wavelength on the optical spectrum of a transmitted optical signal and a specific side peak component spaced apart from the center wavelength by a clock frequency, generating beating signal between the two wavelengths, converting the optical beating signal into electrical signal using a photodiode, and passing the electrical beating signal through a band-pass filter whose center frequency corresponds to a clock frequency. This method utilizes the phenomenon in which beating is generated at a frequency corresponding to the difference between the frequencies of the two wavelengths when two coherent wavelengths having different frequencies are added to each other.

FIG. 1 shows the optical spectrum of an optical communication signal of 40 Gbps that is modulated by a Non-Return-to-Zero (NRZ) modulation method, which is the most widely used one of the optical modulation methods, and is transmitted. It can be appreciated from this drawing that the peak of a center wavelength 100 of a Laser Diode (LD) is located at the center of the spectrum and sidebands 110 and 120 are generated at both sides of the peak of the center wavelength 100 by optical modulation. In particular, two specific side peak wavelengths 130 and 140 are generated in the sidebands 110 and 120 at two positions spaced apart to the right and left from the center wavelength 100 by a clock frequency of 40 GHz, that is, by a wavelength of about 0.32 nm. In order to create a beating signal corresponding to the clock frequency, the center wavelength 100 and one of the two side peak wavelengths 130 and 140 are extracted, and beating signal is generated between the extracted wavelengths.

A conventional optical clock extraction apparatus equipped with a beating signal generation unit 20 to generate a beating signal is shown in FIG. 2a. In a conventional optical clock extraction method, an optical signal transmitted to a receiving end is optically amplified in a preamplifier 200, and then is branched into two signals by an optical coupler 210. One signal passes through a data path 2a to reconstruct data, and the other signal passes through a clock extraction path 2b. A center wavelength and a specific side peak are extracted while the branched optical signal input to the beating signal generation unit 20 passes through a transmission type optical filter 220. FIG. 2b is a Gaussian-type transmission characteristic curve of the optical filter 220. FIG. 2c shows the optical spectrum of the 40 Gbps optical communication signal before the optical signal passes through the Gaussian-type optical filter 220. FIG. 2d shows the optical spectrum of the optical signal that is optically amplified after the optical signal passes through the Gaussian-type optical filter 220 with the left side of a specific side peak wavelength 270 located at the center 260 of the characteristic curve in FIG. 2b. In this case, since a center wavelength 280 is located on the right inclined portion of the transmission characteristic curve, the center wavelength 280 is greatly attenuated, so that the magnitude of the center wavelength 280 becomes similar to that of the specific side peak wavelength. The extracted wavelengths generate beating that is a kind of interference. Since the magnitude of a beating signal is very small, an optical amplifier 230 amplifies the beating signal. An Amplified Spontaneous Emission (ASE) filter 240 may be used to remove an ASE generated at this time. The beating signal is detected in a photodiode 250 as electrical signal, and formed into a clock while passing through a band-pass filter whose center wavelength corresponds to the clock frequency.

The problems of the conventional method lie in the characteristic curve of the transmission optical filter 220. As can be known from FIG. 2d, wavelengths 290 other than the specific side peak wavelength 270 and the center wavelength 280 are simultaneously extracted with little attenuation, and participates in the generation of the beating, so that the beating signal detected by the photodiode 250 includes not only the clock frequency component but also many other frequency components. Accordingly, a clock generated from such beating signal through the band-pass filter is too unstable to be used for data reconstruction.

Additionally, in the case where in order to prevent the above-described problem, the center wavelength and the specific side peak wavelength are separately extracted using two optical filters of narrow bandwidths each corresponds to the center wavelength and one of said side peak respectively. The separately extracted two wavelengths are added to generate beating. In this case however, the following problems arise. That is, since the optical paths, through which the two wavelengths pass, become different, relative phases and polarizations between the two wavelengths are not fixed but drift depending on the variations of surrounding environments, which causes the phase and amplitude of a finally-generated clock to drift as time elapses. Additionally, if a difference between the optical paths of the two wavelengths is not very smaller with respect to the coherence length of a laser diode, non-negligible phase noise is generated due to the finite coherency of the laser diode and, therefore, the quality of the finally generated clock is lowered.

Meanwhile, for a method of extracting a clock from an NRZ modulated optical signal, a method of extracting a clock in a high-speed (greater than 40 Gbit/s) NRZ transmission system using optical signal processing other than electrical signal processing is disclosed in the thesis of Bernd Franz, “Optical signal processing for very high speed (>40 Gbit/s) ETDM binary NRZ clock recovery”, Optical Fiber Communication Conference, OFC2001, pp MG1-1˜MG1-3, 2001. Additionally, in U.S. Published patent application US20020009159, there is disclosed an “Optical Receiver” that reduces the functions of electronic components, in particular, nonlinear components, at the time of extracting a clock signal from a NRZ data sequence received in an optical receiving end. In the thesis and the patent application, necessary optical components for optical beating signal are simultaneously extracted from the branched received optical signal using one Gaussian-type transmission optical filter, and then the possibility of clock generation was suggested using the optical beating signal. However, in this case, the clock can be generated but the extracted optical components will have low spectral purity, so that the generation of a stable clock is difficult. Additionally, in the thesis and the patent application, a method of increasing the transmission distance of the optical communication signal is not disclosed.

### SUMMARY OF THE INVENTION

The present invention provides a clock extraction apparatus and method for an optical communication signal, in which minimum line widths of center wavelength and a specific side peak wavelength are simultaneously extracted from the received digital optical signal where the magnitudes of the two wavelengths are regulated to be similar, and optical beating is generated between the two simultaneously extracted and regulated wavelengths, thus extracting a high quality clock.

Another object of the present invention is to provide a clock extraction apparatus for an optical communication signal, which transmits an amplified side peak wavelength component which participates in the generation of beating signal for optical clock extraction, thereby considerably increasing the transmission distance of the optical signal by optical clock extraction.

In order to accomplish the above object, the present invention provides a clock extraction apparatus for an optical signal, including optical branching means for branching an optical signal, which has been transmitted from a transmitting end to an receiving end, into a plurality of optical signals to be transmitted to a plurality of paths; optical filtering means for simultaneously reflecting a center wavelength and a specific side peak wavelength of the optical signal, which has been transmitted to one of the plurality of paths, from the optical branching means, the specific side peak wavelength being spaced apart from the center wavelength by a clock frequency; and clock extraction means for extracting a clock by detecting and band pass filtering the optical beating signal of the center wavelength and the specific side peak wavelength reflected backward to the optical branching means.

Preferably, the clock extraction apparatus may further include clock amplification means for amplifying the center wavelength and the specific side peak wavelength reflected from the optical filtering means to the optical branching means, and/or a noise filtering means for removing noise included when amplifying the reflected center wavelength and the side peak wavelength.

Preferably, the optical filtering means may have a main reflection band and a sub-reflection band, and reflects each of the wavelengths in each of the reflection bands. More preferably, the optical filtering means may reflect the side peak wavelength using the main reflection band and reflect the center wavelength using the sub-reflection band. In particular, the optical filtering means may adjust the reflectivity of the sub-reflection band so that the magnitudes of the center wavelength and the side peak wavelength are substantially equal after the wavelengths are reflected.

Preferably, the transmitting end includes optical amplifying means for selective optical amplification of the magnitude of the specific side peak wavelength(s) spaced apart from the center wavelength by the clock frequency. More preferably, the transmitting end may include electrical coupling means for adding a portion of electrical clock signal to an electrical data signal before modulating the optical signal that will be transmitted to the receiving end for selective amplification of the magnitude of the specific side peak wavelength(s) spaced apart from the center wavelength by the clock frequency.

In order to accomplish the above object, the present invention provides a clock extraction method for an optical communication signal, including the steps of receiving an optical signal transmitted from a transmitting end; branching the optical signal into two or more optical signals; simultaneous optical filtering of the center wavelength and one of specific side peak wavelength spaced apart from the center wavelength by a clock frequency from a first optical signal of the branched two or more optical signals

Preferably, the clock extraction method may further include the step of amplifying the extracted center wavelength and specific side peak wavelength of the first optical signal.

Preferably, the clock extraction method may further include the step of removing optical noise included when amplifying the extracted wavelengths.

Preferably, the step of optically filtering the first optical signal may be performed by simultaneously reflecting each of the wavelengths in each of a main reflection band and a sub-reflection band. More preferably, the step of optically filtering the first optical signal is performed by reflecting the side peak wavelength using the main reflection band and reflecting the center wavelength using the sub-reflection band. In particular, the step of optically filtering the first optical signal may be performed by adjusting the reflectivity of the sub-reflection band so that magnitudes of the center wavelength and the side peak wavelength are substantially equal after the wavelengths are reflected.

Preferably, the clock extraction method may further include the step of amplifying only the specific side peak wavelength spaced apart from the center wavelength of the optical signal by the clock frequency, which will be transmitted to the receiving end. More particularly, the clock extraction method may further include the steps of adding an electrical clock signal to an electrical data signal used to modulate the optical signal that will be transmitted to the receiving end; and modulating the optical signal using an electrical signal obtained by adding the electrical clock signal to the electrical data signal, and amplifying the specific side peak wavelength.

### BRIEF DESCRIPTION OF THE DRAWINGS

The above objects, features and advantages of the present invention will be more clearly understood from the following detailed description taken in conjunction with the accompanying drawings, in which:

FIG. 1 is a graph showing the optical spectrum of a conventional optical signal of 40 Gbps modulated by the NRZ modulation method;

FIG. 2a is a diagram showing an example of the construction of a conventional clock extraction apparatus;

FIG. 2b is a graph showing the Gaussian-type transmission characteristic curve of an optical filter shown in FIG. 2a;

FIG. 2c is a graph showing the optical spectrum of an optical signal before the optical signal passes through the optical filter shown in FIG. 2a;

FIG. 2d is a graph showing the optical spectrum of the optical signal after the optical signal passes through the optical filter shown in FIG. 2a;

FIG. 3 is a schematic diagram showing the construction of an optical clock extraction apparatus according to an embodiment of the present invention;

FIG. 4 is a graph showing the reflection characteristic curve of a reflection optical filter applied to the present invention;

FIG. 5 is a graph showing the optical spectrum of two extracted optical components according to the present invention;

FIG. 6 is a view of a clock signal of 40 GHz generated according to an embodiment of the present invention;

FIG. 7 is a flowchart showing a process of extracting a clock from an optical signal according to the present invention;

FIG. 8a is a schematic view of a simplified long distance optical communication path;

FIG. 8b is a graph illustrating ASE noise accumulated while passing through optical amplifiers shown in FIG. 8a;

FIG. 9 is a graph showing the spectrum of the optical signal in which a specific side peak wavelength is amplified according to the present invention;

FIG. 10 is a diagram showing the construction of a transmitter for amplifying a side peak wavelength through the change of a modulation method of the optical signal according to the present invention; and

FIG. 11 is a diagram showing a construction for amplifying the side peak wavelength at a transmitting end according to another embodiment of the present invention.

### DESCRIPTION OF THE PREFERRED EMBODIMENTS

Reference now should be made to the drawings, in which the same reference numerals are used throughout the different drawings to designate the same or similar components.

Hereinafter, a preferred embodiment of the present invention will be described in detail with reference to the accompanying drawings.

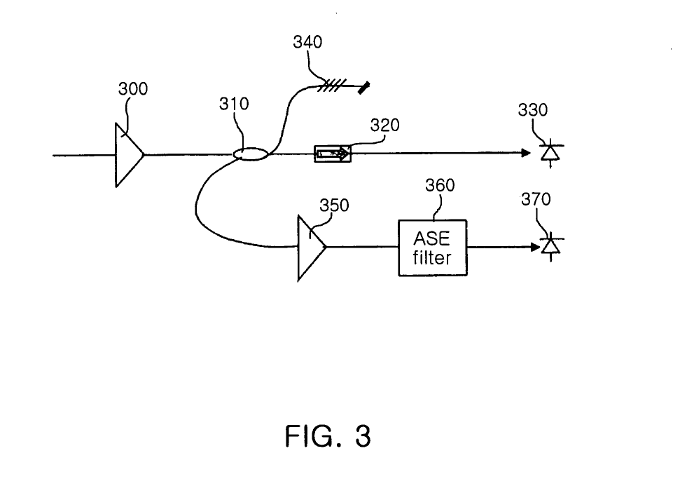

FIG. 3 is a schematic diagram showing the construction of an optical clock extraction apparatus according to an embodiment of the present invention, which is a conceptual view of an entire receiving end including an optical clock extraction function. Referring to FIG. 3, the optical clock extraction apparatus of the present invention will be described with an NRZ modulated optical signal of 40 Gbps cited as an example. As shown in FIG. 3, the optical signal received at the receiving end is optically amplified by a preamplifier 300, and then is branched into two signals by a 2 ×2 optical coupler 310 to be transmitted to a data path and a clock extraction path, respectively. An optical signal passing through the data path of the two paths is converted by a photodiode 330 through optical-electrical conversion and then input to a data reconstruction circuit. In an optical signal used for clock extraction, a center wavelength and a specific peak wavelength, which is spaced apart from the center wavelength by a clock frequency, are simultaneously reflected from a single band reflecting type optical filter 340 having a specific reflection spectrum, moved in a backward direction through the 2×2 optical coupler 310, optically amplified by a clock amplifier 350, passed through an ASE filter 360 for noise removal, and detected as a beating signal by a photodiode 370.

As described above, the frequency of the electrical beating signal generated through optical-electrical conversion is the same as the clock frequency, but somewhat includes jitter components. Accordingly, the beating signal may become a final clock signal after passing through an electrical band-pass filter, whose center frequency corresponds to a clock frequency and whose pass bandwidth is very narrow. If necessary, the beat signal is electrically amplified and input to the data reconstruction circuit as a clock.

The present invention and the related art are compared with each other in detail below. In the relate art, a necessary side peak wavelength and a necessary center wavelength are extracted using a single optical filter whose transmission spectrum is Gaussian type. In this case, in order to allow the magnitudes of the side peak wavelength and the center wavelength to be similar to each other, the side peak wavelength is located at the center of the transmission characteristic curve of the optical filter. At this time, the center wavelength is spaced apart from the center of the transmission characteristic curve by about 0.32 nm, so that the center wavelength is automatically decreased by several tens of dB according to the transmission characteristic curve. Accordingly, the magnitudes of the side peak wavelength and the central wavelength are similar to each other after passing through the optical filter. However, many spectral components positioned between the side peak wavelength and the center wavelength are extracted without severe attenuation, and participate in the generation of beating signal. As a result, many other components other than a clock frequency component are included in the beating signal, so that a clock extracted through a band-pass filter is too unstable to be used for data reconstruction.

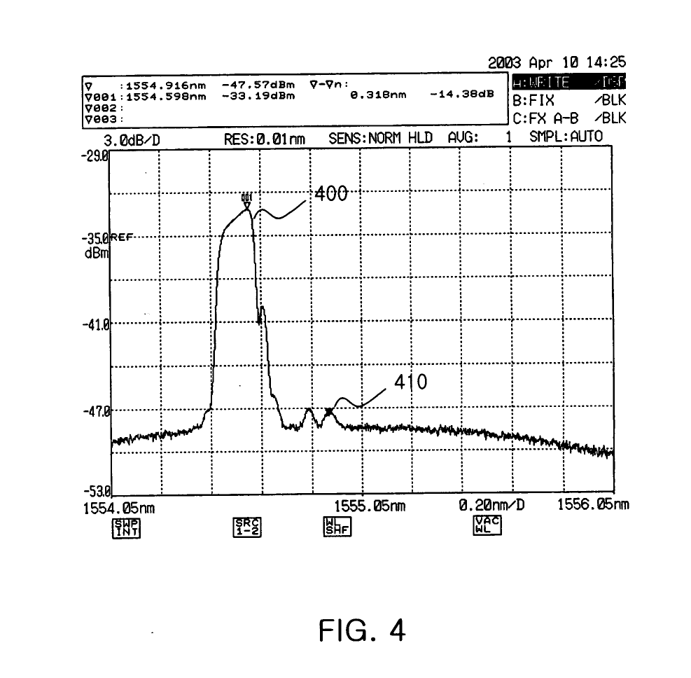

In contrast, in the present invention, a reflection optical filter having a reflection characteristic curve shown in FIG. 4 is applied. A side peak wavelength is reflected using a main reflection band 400, and a center wavelength is reflected using a sub-reflection band 410. Accordingly, a desired side peak wavelength and a desired center wavelength can be extracted, and unnecessary wavelengths can be largely prevented from being extracted. Additionally, the magnitudes of the center wavelength and specific side peak wavelength of the original optical signal can be made similar to each other using a difference adjustment in the reflectivity of the main reflection band 400 and the sub-reflection band 410.

In the construction of the present invention, the center wavelength and the specific side peak wavelength are simultaneously extracted through a single optical filter, so that the inversion, drift or amplitude variation of the clock do not occur, compared with a construction in which two optical filters extract two wavelengths, respectively.

In FIG. 3, an optical isolator 320 disposed between the 2 ×2 optical coupler 310 and the photodiode 330 on the data path is used to prevent part of an optical signal moving through the data path from being reflected in a reverse direction and participating in the generation of beating for clock extraction.

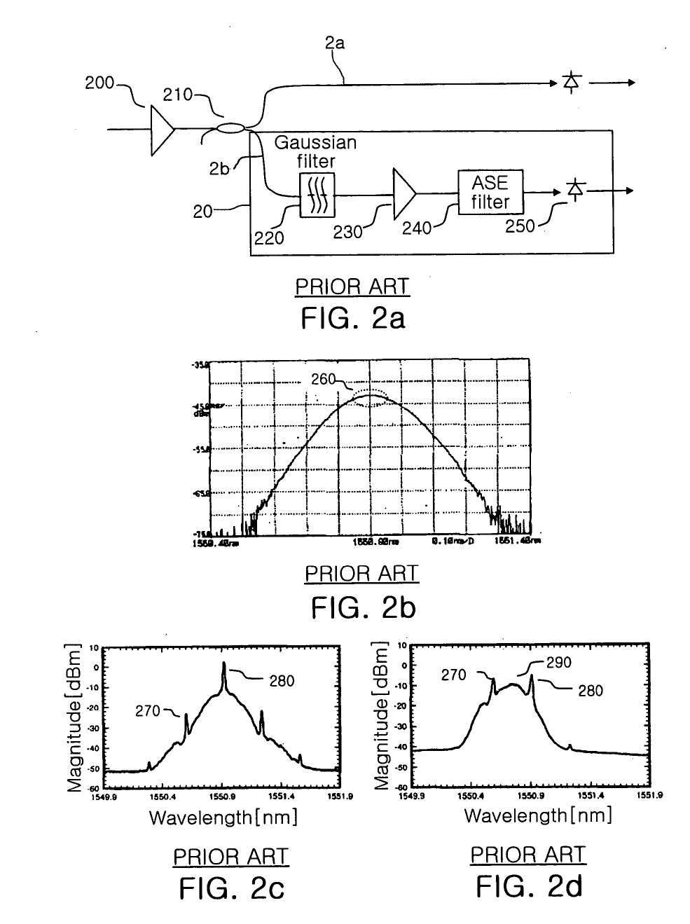

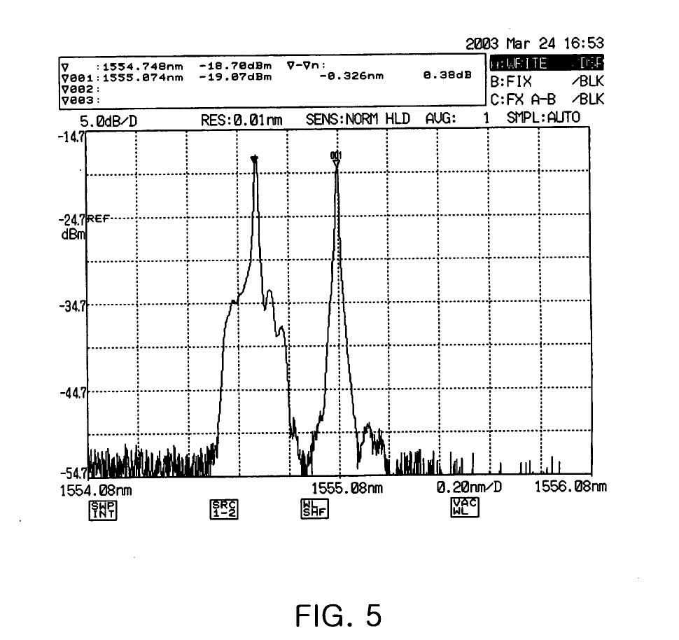

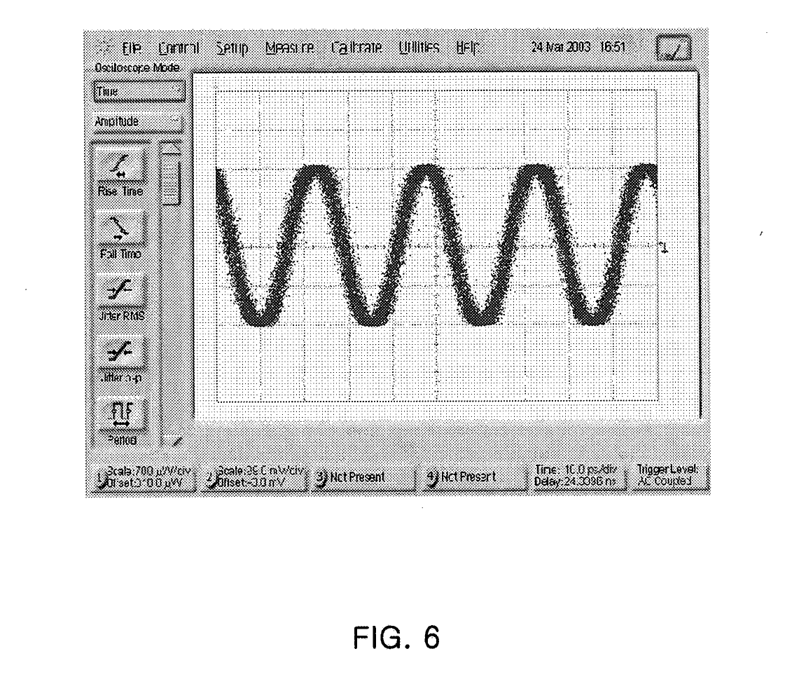

FIG. 5 shows the optical spectrum of two optical components extracted according to the present invention, which presents the spectrum of the extracted center wavelength and the specific side peak wavelength extracted by the optical clock extraction apparatus shown in FIG. 3. Referring to FIG. 5, it is understood that unnecessary components are greatly reduced, compared with the optical spectrum of the prior art shown in FIG. 2d. FIG. 6 is a view of a clock signal of 40 GHz generated according to an embodiment of the present invention, which shows the clock signal of 40 GHz finally obtained by passing the beating signal of FIG. 5 through a band-pass filter.

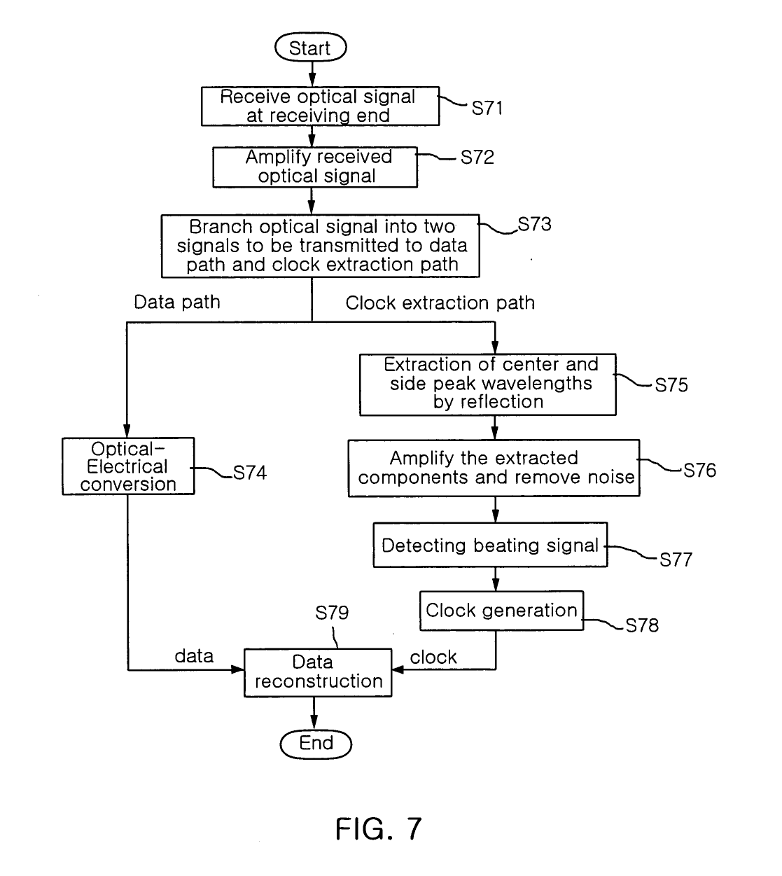

FIG. 7 is a flowchart showing a process of extracting a clock from an optical signal according to the present invention, which represents a process of data reconstruction and clock extraction using an optical signal transmitted to a receiving end in a digital data communication system. As shown in FIG. 7, when a transmitted optical signal is received at the receiving end at step S71, the preamplifier 300 amplifies the optical signal at step S72. In this case, step S71 is preferably performed only if necessary. Thereafter, the optical signal is branched into two signals to be transmitted to the data path and the clock extraction path by the optical coupler 310 at step S73. For the optical signal transmitted to the data path, the optical signal undergoes optical-electrical conversion at step 74, and then is directed to the data reconstructing circuit. The center wavelength and specific side peak wavelength, which is spaced apart from the center wavelength by a clock frequency, of an the optical signal used for clock extraction are simultaneously reflected in the single reflection optical filter 340 having a reflection spectrum shown in FIG. 4 at step S75. The reflected center wavelength and the specific side peak wavelength are amplified and noise is removed from the wavelengths at step S76. Thereafter, a beating signal is detected from the wavelengths at step S77, and then a clock signal is extracted by band-pass filtering the beating signal at step S78. This band pass filtered clock is also directed to the data reconstruction circuit for data recovery at S79.

At step S75, each of the center wavelength and specific side peak wavelength of the optical signal is extracted to have a minimum line width. Preferably, only the center wavelength and the specific side peak wavelength are extracted and reflected without the inclusion of other wavelengths. Additionally, it is preferable that the magnitude of the extracted and reflected center wavelength is substantially equal to that of the specific side peak wavelength.

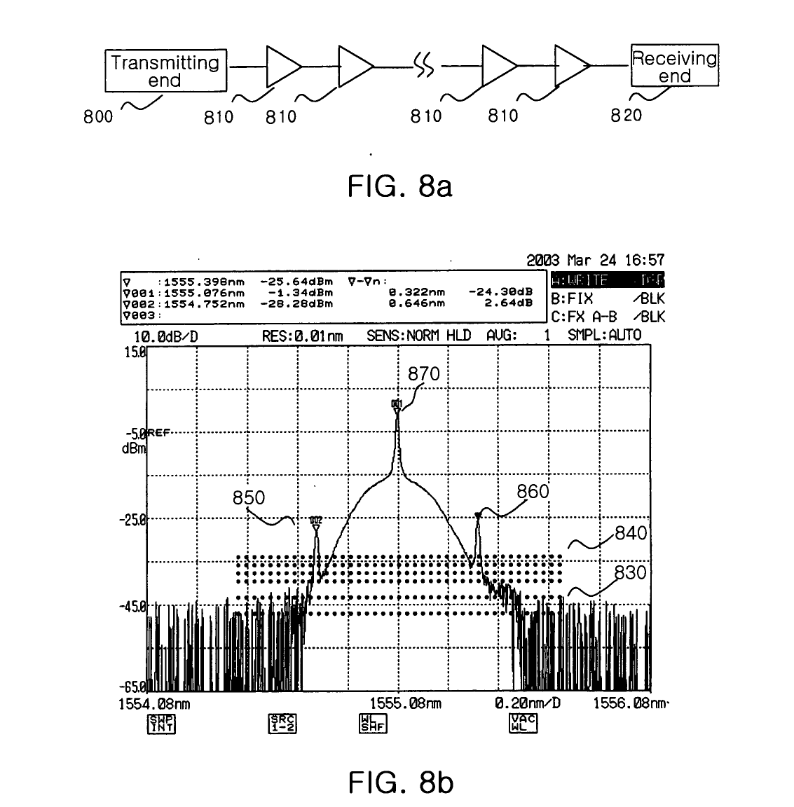

Meanwhile, in order to prevent a transmission distance from being limited due to the deterioration of Optical Signal to Noise Ratio (OSNR) of the side peak wavelength component caused by ASE (amplified spontaneous emission) generated from the optical amplifiers during the long distance transmission of the optical signal, a method of amplifying the ONSR of the side peak wavelength is adopted at a transmission stage. FIG. 8a is a view of a simplified long distance optical communication path. As shown in FIG. 8a, amplifiers 810 are disposed between a transmitting end 800 and a receiving end 820 at approximately 80 km intervals, and amplify an optical signal weaken due to optical loss during transmission. However, ASE noise is always generated during optical amplification and added to transmitted optical signal. The ASE noise accumulated while passing through the optical amplifiers 810 is shown in FIG. 8b. As shown in FIG. 8b, the magnitude of the accumulated ASE noise 830 and 840 generated in the optical amplifier 810 is very smaller than that of a center wavelength 870, but is not negligible with respect to the magnitudes of side peak wavelengths 850 and 860. Accordingly, a beating signal caused by the center wavelength 850 and one of the side peak wavelengths 850 and 860 exhibits great jitter characteristics, so that the generation of a stable clock is difficult.

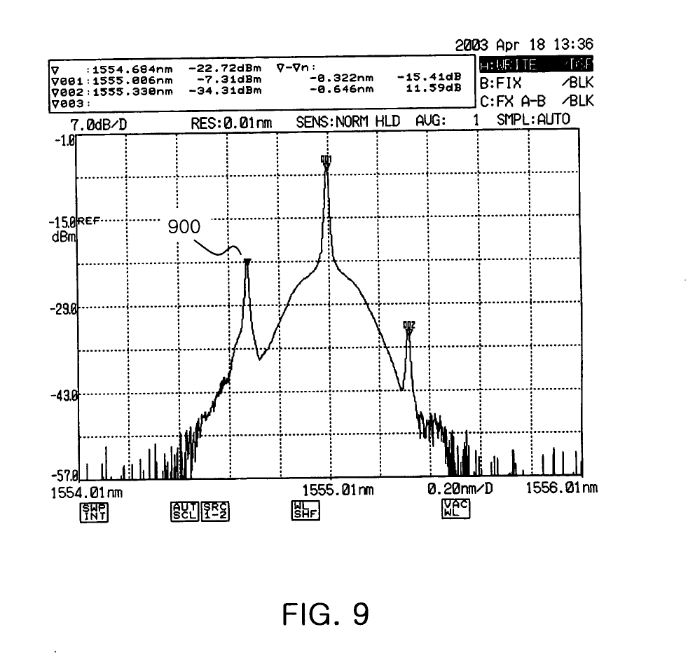

In order to overcome an influence resulting from the ASE noise, as shown in FIG. 9, before the optical signal is transmitted, the component of a specific side peak wavelength 900 is amplified at the transmitting end, transmitted to the receiving end. Thereafter, the transmitted side peak wavelength and the center wavelength are extracted and then used for clock generation. If the component of the specific side peak wavelength 900 is transmitted after being amplified, the OSNR becomes immune to ASE noise, and therefore, a transmission distance is increased. In the data path of the receiving end, after the component of the amplified side peak wavelength 900 is removed, data reconstruction is performed.

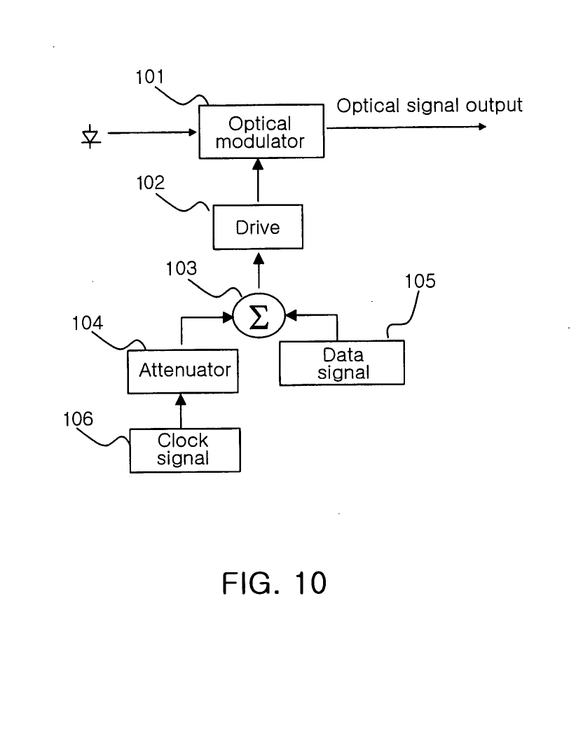

FIG. 10 is a diagram showing the construction of a transmitter for amplifying a side peak wavelength using an electrical method before the output of the transmitter is transmitted, according to the present invention, which represents an additional structure added to a transmitting end to amplify the specific side peak wavelength. As show in FIG. 10, an electrical clock signal 106 is added to an electrical data signal 105 input to an optical modulator 101. The electrical signal obtained by adding the electrical clock signal 106 to the electrical data signal 105 is input to the optical modulator 101 through an optical modulator driver device 102, and optical modulation slightly different from NRZ modulation occurs. Accordingly, an optical signal whose side peak wavelength is amplified can be obtained compared with that obtained by a general method of optical modulating using only a data signal. Additionally, a transmission distance can be extended by transmitting such an optical signal when data is reconstructed at a receiving end. More preferably, an electrical attenuator 104 is added to properly adjust the magnitude of the input clock signal 106.

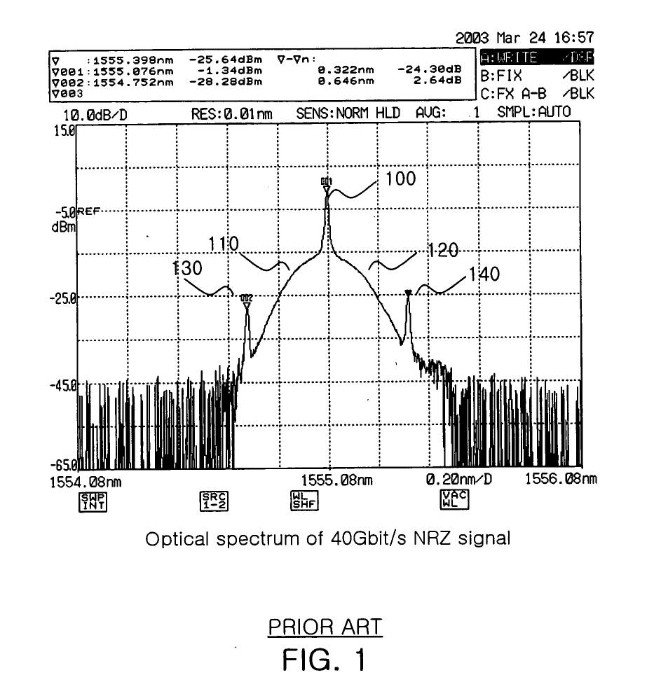

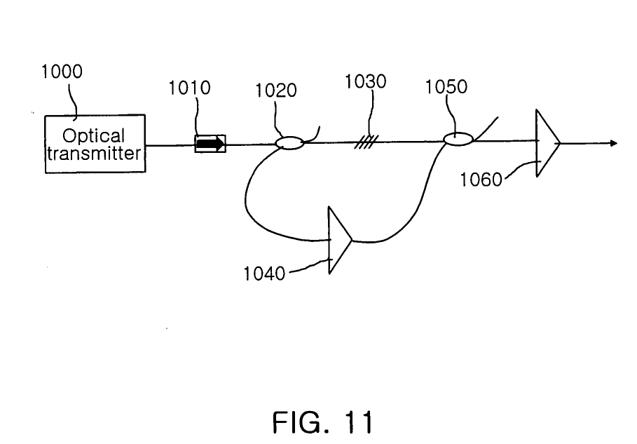

FIG. 11 shows a construction for amplifying the side peak wavelength at the transmitting end using an optical approach, according to another embodiment of the present invention. One of specific side peak wavelengths 130 and 140 of the optical spectrum shown in FIG. 1 is extracted after the general output of a transmitter, optically amplified, and added to the original optical signal from which the side peak wavelength 130 or 140 is extracted. Thereafter, the optical signal, in which the side peak wavelength 130 or 140 is amplified, is transmitted. In this case, an optical filter 1030 reflects only one of the specific side peak wavelengths 130 and 140.

As described above, the present invention provides a clock extraction apparatus and method for an optical signal, which uses a single optical filter, reflects and simultaneously extracts two necessary optical wavelengths, thereby maximally preventing unnecessary optical wavelengths other than the two necessary optical wavelengths from being extracted and, therefore, generating a stable clock.

Additionally, the present invention provides a clock extraction apparatus and method for an optical signal, which generates and transmits an optical signal in which a specific side peak wavelength used for clock generation is amplified at a transmitting end, thereby greatly increasing the transmission distance of the optical signal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A clock extraction apparatus for an optical signal, comprising:
optical branching means for branching an optical signal, which has been transmitted from a transmitting end to a receiving end, into a plurality of optical signals to be transmitted to a plurality of paths;
optical filtering means for simultaneously reflecting a center wavelength and a specific side peak wavelength of the optical signal, which has been transmitted to a first path of the plurality of paths, to the optical branching means, the specific side peak wavelength being spaced apart from the center wavelength by a clock frequency; and
clock extraction means for extracting a clock by detecting a beating signal from the center wavelength and the specific side peak wavelength reflected to the optical branching means.

2. The clock extraction apparatus according to claim 1, further comprising clock amplification means for amplifying the center wavelength and the specific side peak wavelength reflected from the optical filtering means to the optical branching means.

3. The clock extraction apparatus according to claim 2, further comprising noise filtering means for removing optical noise included in the output of the clock amplification means.

4. The clock extraction apparatus according to claim 1, wherein the optical filtering means has a main reflection band and a sub-reflection band, and reflects each of the wavelengths in each of the reflection bands.

5. The clock extraction apparatus according to claim 4, wherein the optical filtering means reflects the side peak wavelength using the main reflection band, and reflects the center wavelength using the sub-reflection band.

6. The clock extraction apparatus according to claim 4, wherein the optical filtering means adjusts reflectivities of the sub-reflection band and the main reflection band so that magnitudes of the center wavelength and the side peak wavelength are substantially equal after the wavelengths are reflected.

7. The clock extraction apparatus according to claim 1, wherein the optical filtering means reflects only the center wavelength and the specific side peak wavelength.

8. The clock extraction apparatus according to claim 1, further comprising a plurality of amplification means positioned at a fore end of the receiving end to amplify the side peak wavelength of the optical signal that will be transmitted to the receiving end.

9. The clock extraction apparatus according to claim 1, wherein the transmitting end comprises:
optical amplifying means for amplifying the magnitude of one of the specific side peak wavelengths spaced apart from the center wavelength by the clock frequency.

10. The clock extraction apparatus according to claim 1, wherein the transmitting end comprises:
coupling means for adding an electrical clock signal to an electrical data signal used to modulate the optical signal that will be transmitted to the receiving end; and
optical modulation means for modulating the optical signal using an electrical signal obtained by adding the electrical clock signal to the electrical data signal.

11. The clock extraction apparatus according to claim 10, wherein the optical modulation means amplifies the specific side peak wavelength of the optically modulated optical signal.

12. The clock extraction apparatus according to claim 10, wherein the optical modulation means amplifies the optical signal so that a magnitude of the specific side peak wavelength of the optical signal is amplified to be greater than that of a specific side peak wavelength generated by a Non-Return-to-Zero (NRZ) modulation.

13. A clock extraction method for an optical signal, comprising the steps of:
receiving an optical signal transmitted from a transmitting end;
branching the optical signal into two or more optical signals;
optically filtering a first optical signal of the two or more optical signals by simultaneously reflecting the center wavelength of the first optical signal and a specific side peak wavelength spaced apart from the center wavelength by a clock frequency; and
extracting a clock by detecting the beating signal from the reflected center wavelength and specific side peak wavelength of the first optical signal.

14. The clock extraction method according to claim 13, further comprising the step of:
optically amplifying the extracted and reflected center wavelength and specific side peak wavelength of the first optical signal.

15. The clock extraction method according to claim 13 or 14, further comprising the step of:
removing optical noise added to the optically amplified center wavelength and the side peak wavelength.

16. The clock extraction method according to claim 13, wherein the step of optically filtering the first optical signal is performed by simultaneously reflecting each of the wavelengths in each of a main reflection band and a sub-reflection band of an optical filter.

17. The clock extraction method according to claim 16, wherein the step of optically filtering the first optical signal is performed by reflecting the side peak wavelength using the main reflection band and reflecting the center wavelength using the sub-reflection band.

18. The clock extraction method according to claim 17, wherein the step of optically filtering the first optical signal is performed by adjusting reflectivity of the sub-reflection band so that magnitudes of the center wavelength and the side peak wavelength are substantially equal after the wavelengths are reflected.

19. The clock extraction method according to claim 13, further comprising the step of:
amplifying the side peak wavelength of the optical signal, which will be transmitted to the receiving end, at least once at a fore end of the receiving end.

20. The clock extraction method according to claim 13, further comprising the step of:
amplifying the center wavelength and specific side peak wavelength of the optical signal that will be transmitted to the receiving end, the specific side peak wavelength being spaced apart from the center wavelength by the clock frequency.

21. The clock extraction method according to claim 13, further comprising the step of:
amplifying only the specific side peak wavelength spaced apart from the center wavelength of the optical signal, which will be transmitted to the receiving end, by the clock frequency.

22. The clock extraction method according to claim 13, further comprising the steps of:
adding an electrical clock signal to an electrical data signal used to modulate the optical signal that will be transmitted to the receiving end; and
optically modulating the optical signal using an electrical signal obtained by adding the electrical clock signal to the electrical data signal, and amplifying the specific side peak wavelength.

23. The clock extraction method according to claim 22, wherein a magnitude of the specific side peak wavelength of the optical signal is amplified to be greater than that of the specific side peak wavelength generated by an NRZ modulation.
